(19) United States
(12) Patent Application Publication
(10) Pub. No.: US 2019/0165536 A1
(43) Pub. Date: May 30, 2019

(54) COAXIAL CABLE CONNECTOR WITH DISPENSABLE RF INSULATOR AND METHOD OF MAKING THE SAME

(71) Applicant: Corning Optical Communications RF LLC, Glendale, AZ (US)

(72) Inventors: Steven Bruce Dawes, Corning, NY (US); Lisa Ann Hogue, Corning, NY (US); Charlotte Diane Milia, Corning, NY (US); Casey Roy Stein, Surprise, AZ (US)

(21) Appl. No.: 16/184,172

(22) Filed: Nov. 8, 2018

Related U.S. Application Data
(60) Provisional application No. 62/591,899, filed on Nov. 29, 2017.

(51) Int. Cl. H01R 43/24; H01R 9/05

(52) U.S. Cl. CPC H01R 43/24; H01R 9/05

(57) ABSTRACT

A method for making an RF connector having an outer conductor and an inner conductor comprises pre-plating the outer conductor and the inner conductor of the connector with corrosion-resistant metallic material. The method also comprises injecting a material comprising polyimide/poly(silsesquioxane)-like nanocomposite material in a volume between the outer conductor and the inner conductor of the connector. The method further comprises heating the connector with the injected material to a temperature between about 150 C to about 380 C in a substantially dry nitrogen-based environment.

### CROSS-REFERENCE TO RELATED APPLICATIONS

This application claims the benefit of priority under 35 U.S.C. §119 to U.S. Provisional Application No. 62/591,899 filed on Nov. 29, 2017, the content of which is relied upon and incorporated herein by reference in its entirety.

### FIELD

The disclosure relates generally to radio frequency (RF) connectors and, more particularly, to coaxial cable connectors having dielectric material that is formable at lower temperatures to preserve pre-plating of the metallic parts of the connector.

### BACKGROUND

Currently, insulators and dielectrics are made of many non-conductive materials such as plastics, glass ceramics and epoxies. In the case of high-temperature (165 C-400 C) applications, glass and ceramics are primarily used. The main purpose of these dielectric materials is to electrically isolate the connector components from one another. For RF connectors; the dielectric material provides a consistent favorable dielectric constant to maintain specific impedance (25-300 ohms, more specifically 50-75 ohms). A dielectric constant of 1 -10 is generally required. More specifically, a dielectric constant of 2-5 is preferred. It is important that this dielectric constant be constant over a wide range of operating frequencies (DC-140 GHz). Also, the dielectric constant should be low loss with a loss tangent less than 0.01. In some cases, the secondary purpose of insulators is to hermetically seal the connector.

Most connectors require some level of surface treatment, primarily nickel and/or gold plating, to ensure that the connectors will not corrode leading to changes in its electrical performance. Typically, plated parts cannot be subjected to high temperatures (450° C.) for a period of time generally ranging from about 3-5 minutes. However, the current process for the glass ceramics as insulators is at temperatures ranging from about 800° C.-1050° C.

One problem with glass and ceramic dielectric materials is that glass pre-forms are typically required to be stocked for every size dielectric needed. New pre-forms are a significant lead time and expense from the vendor, whereas lower temperature dielectrics use a resin that can be melted and formed into any number of sizes/shapes required.

Consequently, there is an unresolved need for a process of manufacturing coaxial dielectrics having the ability to withstand similar processes that are used in the current high temp/hermetic material and process, while employing materials and manufacturing processes which allows for pre-plated components to be assembled with the new insulator. In accordance with certain embodiments of the present disclosure, one objective is to replace glass ceramics with a material which can be processed at much lower temperatures (150 C-380 C, vs. 800 C-1050 C), therefore allowing for pre-plated parts to be processed.

No admission is made that any reference cited herein constitutes prior art. Applicant expressly reserves the right to challenge the accuracy and pertinence of any cited documents.

### SUMMARY

One embodiment of the disclosure relates to a method for making an RF connector having an outer conductor and an inner conductor comprising pre-plating the outer conductor and the inner conductor of the connector with corrosion-resistant metallic material. The method may also comprise injecting a material comprising polyimide/poly(silsesquioxane)-like nanocomposite material in a volume between the outer conductor and the inner conductor of the connector. The method may further comprise heating the connector with the injected material to a temperature between about 150° C. to about 380° C. in a substantially dry nitrogen-based environment, and allowing the connector to cool.

Another embodiment of the disclosure relates to a coaxial cable connector, comprising an inner conductor and an outer conductor. The coaxial cable connector may also comprise a dielectric material comprising polyimide/poly(silsesquioxane)-like nanocomposite material disposed in a volume between the outer conductor and the inner conductor of the connector.

Yet another embodiment of the disclosure is directed to a coaxial cable connector, manufactured by a method comprising the steps of pre-plating the outer conductor and the inner conductor of the connector with corrosion-resistant metallic material, injecting a material comprising polyimide/poly(silsesquioxane)-like nanocomposite material in a volume between the outer conductor and the inner conductor of the connector, heating the connector with the injected material to a temperature between about 150° C. to about 380° C. in a substantially dry nitrogen-based environment, and allowing the connector to cool.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is perspective view of a feed-through connector having a polyimide/poly(silsesquioxane)-like nanocomposite dielectric manufactured using a method consistent with the disclosed embodiments;

FIG. 2 is perspective view of a single position connector using the feed-through connector in FIG. 1, in accordance with the disclosed embodiments;

FIG. 3 is perspective view of a multi-position block connector using the feed-through connector in FIG. 1 and/or the single position connector of FIG. 2, consistent with the disclosed embodiments;

FIG. 4 is a perspective view of a multi-contact connector having a polyimide/poly(silsesquioxane)-like nanocomposite dielectric manufactured using a method in accordance with the disclosed embodiments;

FIG. 5 is a cross-sectional view of the coaxial cable connector set within an exemplary fixture used in an exemplary method for manufacturing the coaxial cable connector, consistent with certain disclosed embodiments;

FIG. 6 is a cross-sectional view of a multi-position block connector shown in FIG. 2 manufactured using a method in accordance with certain disclosed embodiments;

FIG. 7 is a cross-sectional view of an angled coaxial connector manufactured using a method consistent with certain disclosed embodiments; and

FIG. 8 is a cross-sectional view of an anti-rotation connector manufactured using a method in accordance with certain disclosed embodiments.

### DETAILED DESCRIPTION

Reference will now be made in detail to the present preferred embodiments, examples of which is/are illustrated in the accompanying drawings. Whenever possible, the same reference numerals will be used throughout the drawings to refer to the same or like parts.

Systems and methods consistent with the disclosed embodiments relate to a process for manufacturing coaxial cable connectors in such a way as to facilitate the use of dielectric materials that can be more flexibly formed or used at lower temperatures, to avoid damage to pre-plated components that occur at high temperatures, while having the performance characteristics that are usually associated with glass and ceramic dielectrics.

Processes consistent with the disclosed embodiments involve the use of a dielectric comprising primarily an organic/inorganic hybrid material, such as, for example, a low-dielectric polyimide/poly(silsesquioxane)-like nanocomposite material (sometimes referred to as “PI-PSSQ”). PI-PSSQ is advantageous because of its dielectric properties similar to glass or ceramics while still being able to be processed at lower enough temperatures which will not deteriorate the plating of the components.

A method for making an RF connector having an outer conductor and an inner conductor comprising pre-plating the outer conductor and the inner conductor of the connector with corrosion-resistant metallic material, such as gold, nickel, or other suitable anti-corrosion metallic material. The process may also involve injecting a material comprising polyimide/poly(silsesquioxane)-like nanocomposite material in a volume between the outer conductor and the inner conductor of the connector. The connector with the injected material may then be heated to a temperature between about 150 C to about 380 C in a substantially dry nitrogen-based environment and allowed the connector to cool.

A mold 500 for injecting the PI-PSSQ dielectric material and forming the connector is illustrated in FIG. 5. As shown in FIG. 5, the (pre-plated) inner conductor 105 and (pre-plated) outer conductor 110 may be placed between two halves of a reusable Teflon (or similar) fixture. PI-PSSQ dielectric material 120 may be placed between the volume formed between the inner conductor 105 and outer conductor 110, and the Teflon mold may be placed within a metal fixture, which may be placed in an oven for heating/curing of the dielectric material.

According to an exemplary embodiment, the resin may be cured using a specialized oven developed for curing polyimide which uses NMP solvent and cures at around the same temperature as the invention. The oven uses a nitrogen and partial vacuum atmosphere to ensure a low oxygen/low water vapor environment is present while curing.

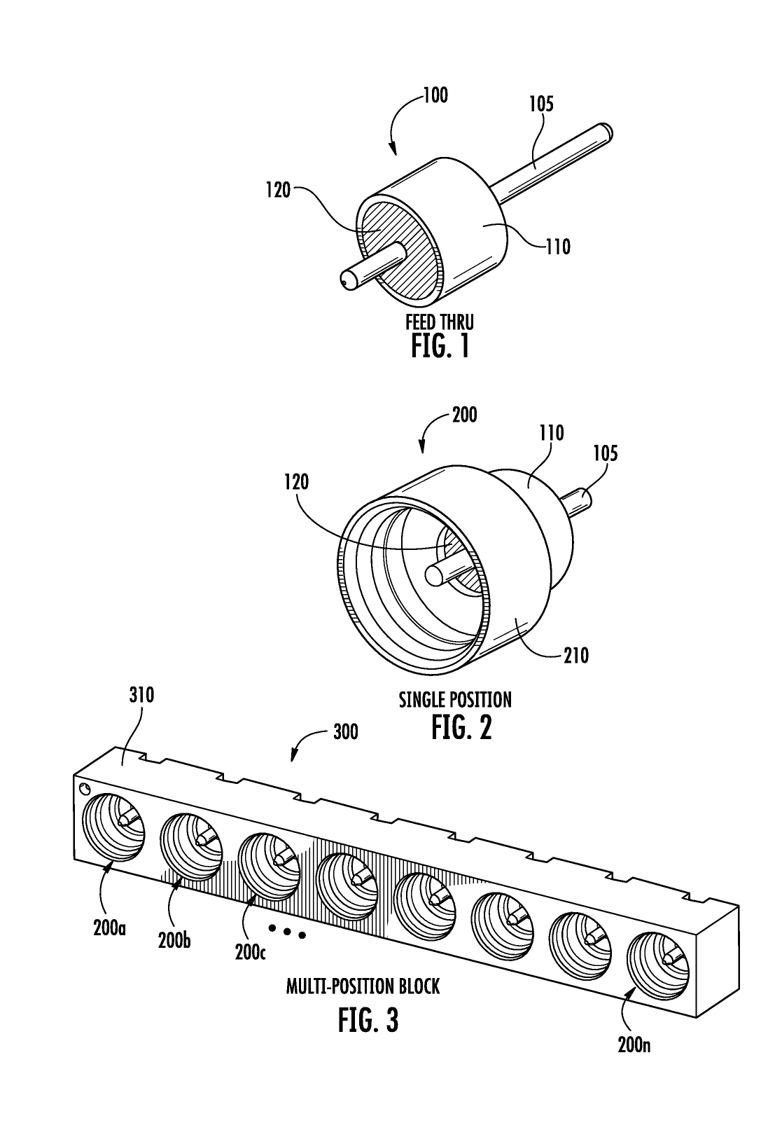

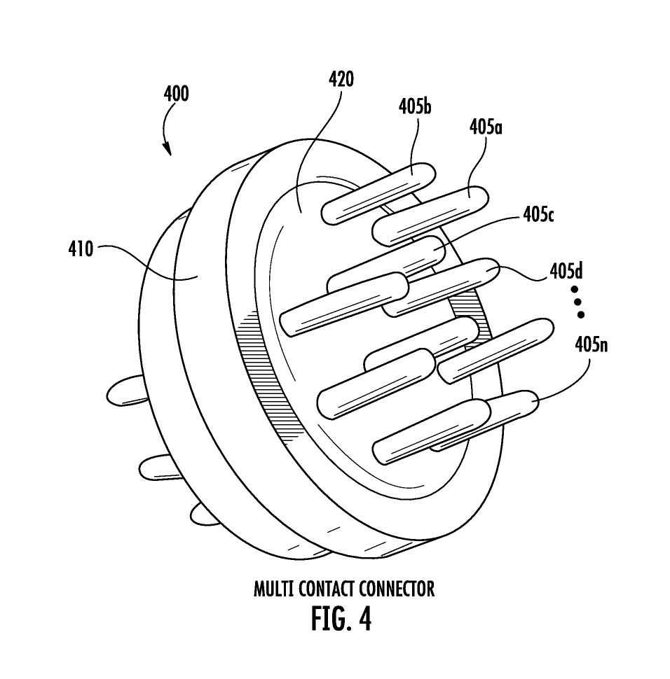

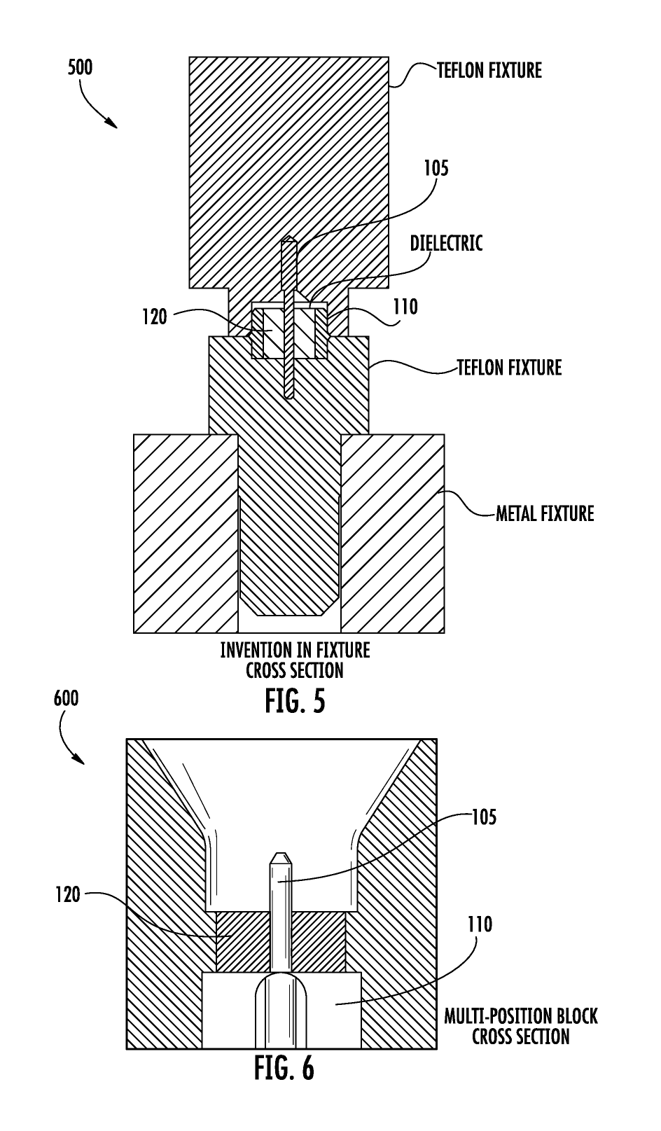

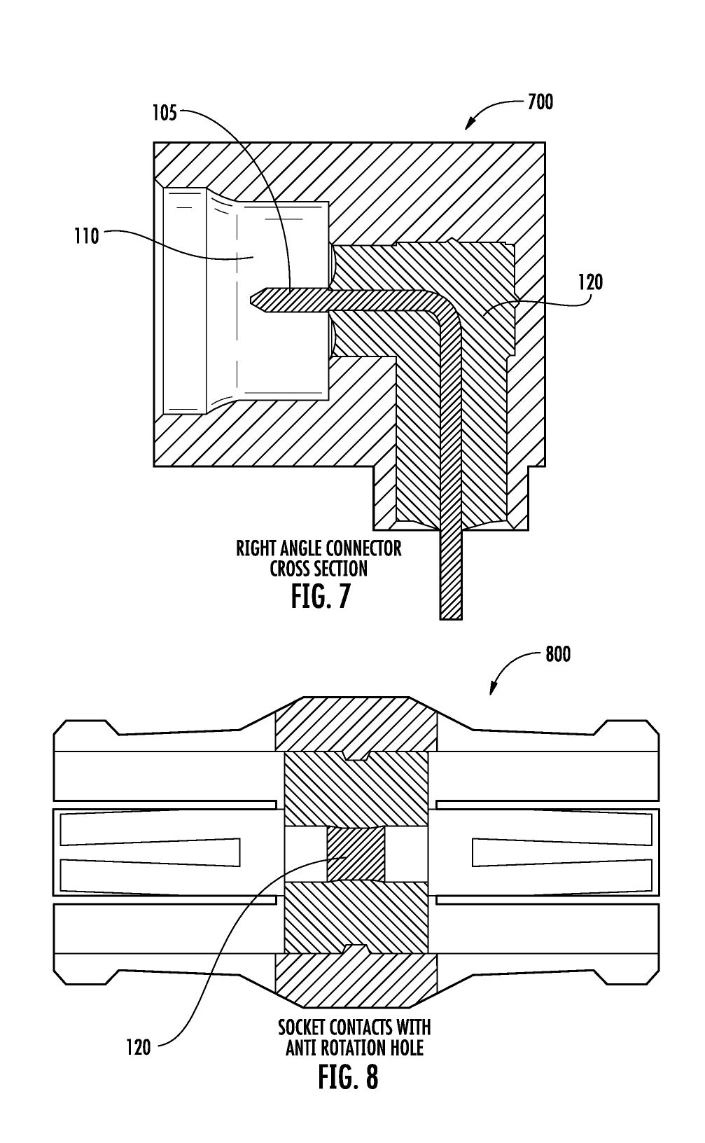

FIGS. 1-4 and 6-8 provide views of different embodiments of connectors that may be manufactured in accordance with the presently-disclosed processes. Indeed, processes and methods consistent with the disclosed embodiments are particularly useful when different sizes/shapes of dielectric material are present, since the PI-PSSQ materials used are injectable/flowable/formable under relatively low heat when compared with glass or ceramic components.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method for making an RF connector having an outer conductor and an inner conductor comprising:
pre-plating the outer conductor and the inner conductor of the connector with corrosion-resistant metallic material;
injecting a material comprising polyimide/poly(silsesquioxane)-like nanocomposite material in a volume between the outer conductor and the inner conductor of the connector;
heating the connector with the injected material to a temperature between about 150 C to about 380 C in a substantially dry nitrogen-based environment; and
allowing the connector to cool.

2. The method of claim 1, wherein the method further comprises inserting, prior to the step of injecting of the material, the pre-plated outer conductor and pre-plated inner conductor into a removable fixture.

3. The method of claim 2, wherein the fixture is a Teflon-based fixture.

4. The method of claim 2, wherein the fixture is a Teflon-based filter set within a metallic fixture.

5. The method of claim 1, wherein the RF connector is a coaxial connector and the inner conductor is a center conducting pin.

6. The method of claim 1, wherein injecting the material further comprises dispensing the material by an automated CNC dispensing system using a syringe.

7. The method of claim 1, wherein injecting the material further comprises dispensing the material by an automated CNC dispensing system using jetting technology.

8. The method of claim 1, wherein heating the connector with the injected material comprises heating the connector by an oven that uses a nitrogen and partial-vacuum atmosphere.

9. The method of claim 1, wherein the inner conductor includes a plurality of inner conductors forming a multi-pin connector.

10. A coaxial cable connector, comprising:
an inner conductor and an outer conductor; and
a dielectric material comprising polyimide/poly(silsesquioxane)-like nanocomposite material disposed in a volume between the outer conductor and the inner conductor of the connector.

11. The coaxial connector of claim 10, wherein the inner conductor includes a plurality of inner conductors forming a multi-pin connector.

12. A coaxial cable connector, manufactured by a method comprising the steps of:
pre-plating the outer conductor and the inner conductor of the connector with corrosion-resistant metallic material;
injecting a material comprising polyimide/poly(silsesquioxane)-like nanocomposite material in a volume between the outer conductor and the inner conductor of the connector;
heating the connector with the injected material to a temperature between about 150 C to about 380 C in a substantially dry nitrogen-based environment; and
allowing the connector to cool.
